(19) United States
(12) Patent Application Publication
(10) Pub. No.: US 2003/0090150 A1
(43) Pub. Date: May 15, 2003

(54) Braking device for vehicles

(76) Inventor: Min Su Woo, Gunpo-si (KR)

Correspondence Address: Pennie & Edmonds, LLP, 3300 Hillview Avenue, Palo Alto, CA, 94304, US

(21) Appl. No.: 10/289,814

(22) Filed: Nov. 6, 2002

(30) Foreign Application Priority Data
Nov. 9, 2001 (KR) 2001-69692
Nov. 9, 2001 (KR) 2001-69693

(51) Int. Cl. B60T 8/32

(52) U.S. Cl. 303/191; 188/2 D

(57) ABSTRACT

The present invention relates to a braking device for vehicles capable of preventing any further accidents subsequent to an initial vehicle collision by automatically operating a parking brake upon the collision. The braking device of the present invention comprises a collision sensing means for sensing a vehicle collision and outputting a signal corresponding thereto, and an emergency braking means for causing a parking brake to perform a braking operation in response to the signal from the collision sensing means.

### FIELD OF THE INVENTION

The present invention relates to a braking device for vehicles, and more particularly, to an emergency braking device for automatically operating a parking brake upon a collision.

### BACKGROUND OF THE INVENTION

Generally, a braking device for vehicles includes a service brake and a parking brake. The service brake is used to allow a driver to reduce the speed of the vehicle or halt the vehicle, whereas the parking brake is used to keep the vehicle stationary so as not to move when the vehicle is parked. In general, a brake that a driver operates with his/her foot has been used for the service brake, whereas foot and hand brakes have been used for the parking brake. Such conventional braking systems typically utilize hydraulic systems employing tubing and a master cylinder to contain brake fluid and deliver braking force to the wheels.

However, in conventional braking devices constructed as such, when a collision occurs, the hydraulic master cylinder and hydraulic tubing may be damaged. Further, in a case where leakage of brake fluid occurs, the braking operation cannot be accomplished after the collision. Furthermore, in a case where the driver is unconscious from the impact due to the collision, the vehicle cannot be properly braked. Thus, where the vehicle loses the control of braking force due to a collision on a slope, the vehicle may skid on the downward slope or fall down from a steep descent, which may lead to further damage or injury. In a case where the vehicle loses the control of the braking force due to the collision on a flat road, the vehicle may skid toward the other lanes and collide with other vehicles.

Thus, there is a need for a braking device that can be automatically operated in a collision and which does not rely on the hydraulic system.

### SUMMARY OF THE INVENTION

A braking device for vehicles according to an embodiment of the present invention comprises a collision sensing means for sensing a vehicle collision and outputting a signal corresponding thereto, and an emergency braking means for causing a parking brake to perform a braking operation in response to the signal from the collision sensing means. Preferably, the collision sensing means may further comprise a center G sensor unit for sensing impact acceleration, a front G sensor unit for sensing deceleration generated upon a low-speed collision, a safing sensor unit for outputting an impact response signal only when a vehicle is decelerated due to a forward vehicle collision, and a control unit for outputting a control signal in response to input signals from the center G sensor unit, the front G sensor unit and the safing sensor unit. The emergency braking means may comprise a gas generator unit for generating high pressure gas in response to the signal from the collision sensing means, and a spindle for winding a parking cable, which is fastened to a parking brake pedal, by means of the high pressure gas generated from the gas generator unit.

Alternatively, the emergency braking means may comprise a driving unit which is operated in response to the output signal from the collision sensing means, a ratchet unit which is connected to a parking brake cable and is interlocked with the driving unit, and a locking unit for intermittently controlling a rotational operation of the ratchet unit.

In a further alternative embodiment, an accelerometer generates a signal representative of a sudden change in acceleration of the vehicle. An actuating unit is configured to be operatively connected to a brake cable, the actuating unit communicating with the accelerometer to tension the brake cable in response to the signal generated by the accelerometer. Preferably, the device includes plural accelerometers communicating with a control unit, wherein the control unit interprets the signals and outputs an actuating signal to the actuating unit.

In one alternative, the actuating unit comprises a gas generator actuated in response to the signal and a spindle mechanism driven by gas generated by the gas generator. The spindle is configured and dimensioned to wind the brake cable thereon. Preferably, the gas generator comprises a powder ignition device. In another alternative, the actuating unit comprises a motor actuated in response the signal and a rotating arm driven by the motor. The arm is configured and dimension for securing the braking cable to an end thereof. Preferably, a ratchet mechanism cooperates with the rotating arm to secure the arm in a cable tensioned position. Also, the rotating arm may be mounted on a shaft driven by a gear meshed with a gear mounted on the motor.

### BRIEF DESCRIPTION OF THE DRAWINGS

The above and other objects, advantages and features of the present invention will become apparent from the following description of preferred embodiments given in conjunction with the accompanying drawings, in which:

FIG. 1 is a schedmatic view of a braking device for vehicles according to an embodiment of the present invention;

FIG. 2 is a perspective view of an emergency braking means device according to an embodiment of the present invention;

FIG. 3 is a schematic view of a braking device for vehicles according to another embodiment of the present invention; and

FIG. 4 is a perspective view of an emergency braking means according to another embodiment of the present invention.

### DETAILED DESCRIPTION OF THE INVENTION

Hereinafter, preferred embodiments of the present invention will be explained in detail with reference to the accompanying drawings.

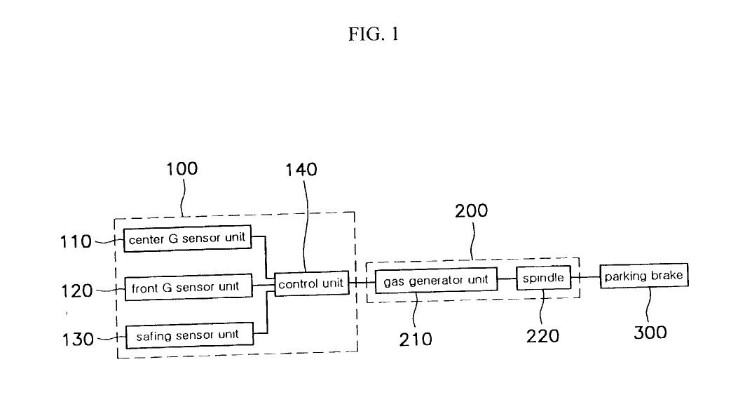

As shown in FIG. 1, a braking device for vehicles according to an embodiment of the present invention comprises a collision sensing means 100 for sensing a vehicle collision and outputting a signal corresponding thereto, and an emergency braking means 200 for causing a foot parking brake 300 to perform a braking operation in response to the signal from the collision sensing means 100.

The collision sensing means 100 may include, for example, an impact sensor employed in an airbag system for protecting a driver or passenger upon vehicle collision. More specifically, the collision sensing means 100 may comprise a center G sensor unit 110 for sensing impact acceleration, a front G sensor unit 120 for sensing deceleration generated upon a low-speed collision, a safing sensor 130 for outputting an impact response signal only when the vehicle is decelerated due to a forward vehicle collision, and a control unit 140 for outputting a control signal in response to input signals from the center G sensor unit 110, the front G sensor unit 120 and the safing sensor unit 130. The center G sensor unit, the front G sensor unit and the safing sensor unit are preferably accelerometers, and may include various types of accelerometers such as mechanical sensor, moving coil sensor, piezoelectric sensor, capacitive sensor and strain gauge sensor, which can be easily understood by those skilled in the art.

Preferably, the center G sensor unit 110 is constructed to have a semiconductor piezoresistor, which is a gauge resistor formed by diffusing a p-type silicon layer onto an n-type silicon substrate. The center G sensor is preferably installed at a central lower portion below the vehicle instrument panel. Such a sensor pay include a cantilever beam. When subjected to deceleration, the beam is deflected due to its mass and the resistance of the gauge resistor changes. Thus, the output of a resistive bridge circuit is changed. Accordingly, a reduction in the speed of a vehicle is sensed.

Preferably, the front G sensor unit 120 is a mechanical accelerometer with an eccentric rotary mass. Such a sensor may comprise a rotor plate mounted with the eccentric mass, rotary and stationary contacts, and a coil spring. The sensor is preferably installed on the front right and left sides within the engine compartment. If deceleration exceeding a deceleration threshold is applied thereto, the rotor plate starts to rotate so that both the contacts come into contact with each other. Thus, the speed of the vehicle is sensed.

Preferably, the safing sensor unit 130 is a mechanical type safing sensor which is in a normal “OFF” state and outputs an “ON” signal if the deceleration is applied thereto. The predetermined deceleration is set to be lower than the threshold values of the center G sensor unit 110 and front G sensor unit 120 and is constructed to respond only to deceleration in a forward vehicle collision. Thus, if the output of the safing sensor 130 does not accompany center G sensor unit 110 and front G sensor unit 120 to a cause other than a collision, it is determined that the collision has not occurred. Therefore, an ignition signal is not outputted. Accordingly, unnecessary operation of the emergency braking means is prevented.

The control unit 140 receives signals from the center G sensor unit 110, the front G sensor unit 120 and the safing sensor unit 130, and outputs a control signal for operating the emergency braking means 200.

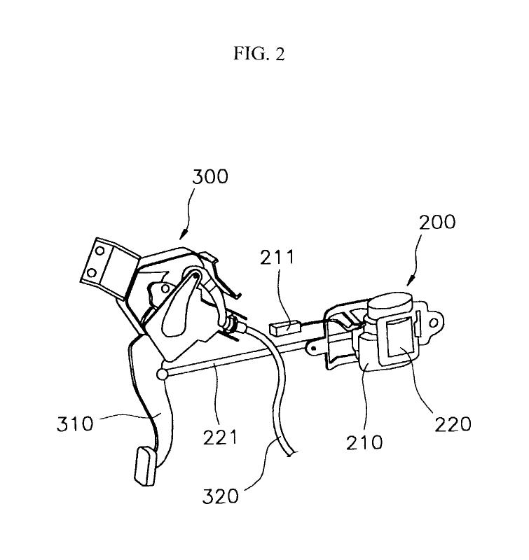

Referring to FIG. 2, the emergency braking means 200 further comprises a gas generator unit 210 for generating high-pressure gas in response to a signal from control unit 140. A spindle 220 winds a braking cable 221, fastened to a parking brake pedal 310, by means of the high-pressure gas generated from the gas generator unit 210.

The gas generator unit 210 is provided with a connector 211 to be connected to the control unit 140 so that it can be operated in response to the control signal from the control unit 140. Further, the gas generator unit 210 is preferably provided with gunpowder that is ignited by the signal outputted from the control unit 140.

The operation of the braking device for vehicles according to the present invention constructed as such is as follows.

If a vehicle collision occurs while a vehicle is running, collision sensing signals are outputted from the center G sensor unit 110, front G sensor unit 120 and safing sensor unit 130, and then transmitted to the control unit 140. The control unit 140, which has received the collision sensing signals, outputs an ignition current for operating the gas generator unit 210 so as to ignite the gunpowder provided in the gas generator unit 210.

An explosion of the gunpowder results in the high-pressure gas within the gas generator unit 210, and the generated high-pressure gas functions as a driving force for rotatably driving the spindle 220. The braking cable 221 is wound by the rotation of the spindle 220 and a force is applied to the parking brake pedal 310 connected to the braking cable 221, so that a parking cable 320 is pulled.

When tension is exerted on the parking cable 320, brake shoes come into close contact with drums coupled to rear wheels and thus emergency braking is established.

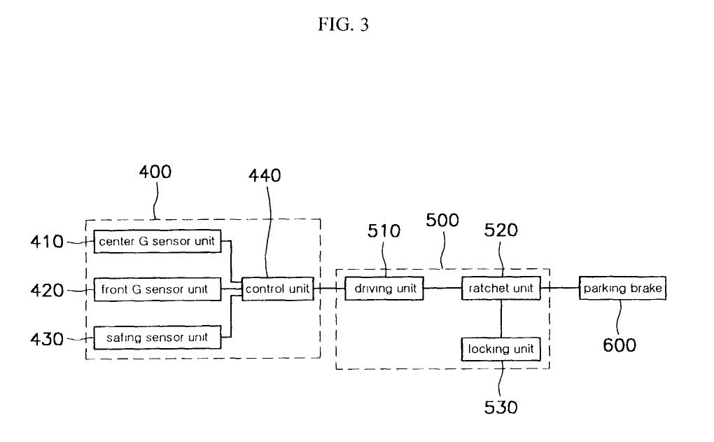

In an alternative embodiment of the present invention as shown in FIG. 3, a collision sensing means 400 senses a vehicle collision and outputs a signal corresponding thereto. An emergency braking means 500 causes a hand parking brake 600 to perform a braking operation in response to the signal from the collision sensing means 400.

The collision sensing means 400 preferably may be an impact sensor as employed in an airbag system for protecting a driver or passenger upon a vehicle collision. A detailed description of means 400 is not repeated since it is the same as that of the first embodiment described above. Generally, reference numeral 410 designates the center G sensor unit, reference numeral 420 designates the front G sensor unit, reference numeral 430 designates the safing sensor unit, and reference numeral 440 designates the control unit. As previously described, control unit 440 receives signals from the center G sensor unit 410, the front G sensor unit 420 and the safing sensor unit 430, and outputs a control signal for operating a driving unit 510 of the emergency braking means 500.

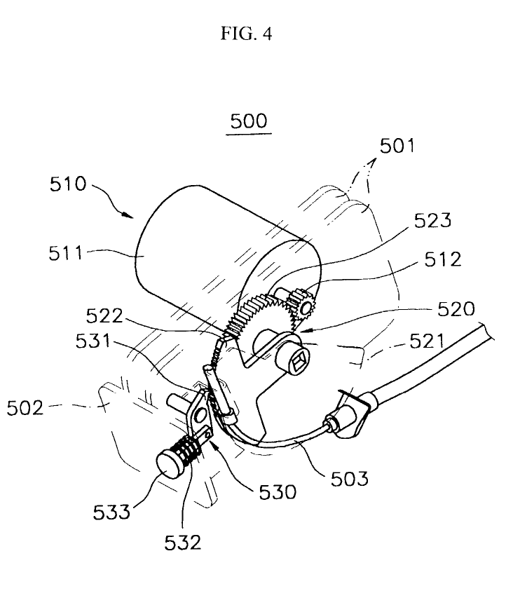

Referring to FIG. 4, alternative emergency braking means 500 comprises the driving unit 510 operated in response to the output signal from the collision sensing means, a ratchet unit 520 connected to a braking cable 503 and interlocked with the driving unit 510, and a locking unit 530 for intermittently controlling a rotational operation of the ratchet unit 520.

The driving unit 510 preferably comprises a motor 511 provided with a first gear 512. The ratchet unit 520 may comprise a braking cable fixing member 521 to which the braking cable 503 is fixed, a ratchet 522 which is driven integrally with the braking cable fixing member 521 and formed with a plurality of teeth, and a second gear 523 which is engaged with the first gear 512 and driven integrally with the ratchet 522.

The locking unit 530 comprises a stopper 531 which has an end to be engaged with the teeth formed in the ratchet 522 and is hingedly fastened to a first bracket 501, and a pin 533. The pin is provided in a second bracket 502 in a state where a spring 532 is resiliently held around the pin so that the stopper 531 supports the ratchet 522 by means of an elastic force of the spring. The first and second brackets 501, 502 are fixed to a frame of a vehicle body.

The braking cable 503, fixed to the braking cable fixing member 521, is connected to an intermediary means for parking brake operation force (not shown). Such an intermediary means is provided in a general parking brake to mediate the braking operation force of the parking brake between the wheels. The parking brake operation force intermediate means may include an equalizer for equally distributing the operation force of the brake lever to the right and left wheels, as is knows in the art.

The operation of the braking device for vehicles according to this alternative embodiment of the present invention is as follows.

If a vehicle collision occurs while a vehicle is running, collision sensing signals are outputted from the center G sensor unit 410, front G sensor unit 420 and safing sensor unit 430, and then transmitted to the control unit 440. The control unit 440 that has received the collision sensing signals outputs the control signal to drive the motor 511.

The rotational driving force of the motor 511 is transmitted to the braking cable fixing member 521 and the ratchet 522 through the first gear 512 and the second gear 523 engaged with the first gear 512. The ratchet unit 520 to which the braking-cable 503 is fixed is rotated by the rotational driving force of the motor 511 so that the braking cable 503 is pulled. Thus, a braking force is produced by the parking brake and the emergency braking of the vehicle is established. The locking unit 530 locks the ratchet 522 to prevent the braking cable 503 from loosening due to reverse rotation of the ratchet 522 while the parking brake is in operation.

As described above, since the braking device for vehicles according to the present invention comprises the collision sensing means, and the emergency braking means for forcibly operating the parking brake upon the vehicle collision, there is an advantage in that additional accidents subsequent to the vehicle collision can be prevented by forcibly braking the vehicle upon the initial collision.

Although the present invention has been described in connection with the preferred embodiments with reference to the accompanying drawings, the preferred embodiments are intended not to limit the invention but to exemplify best modes of the present invention. It will be understood by those skilled in the art that various changes or modifications may be made thereto without departing from the spirit and scope of the invention. Therefore, the present invention is defined only by the appended claims which should be construed as covering such changes or modifications.

What is claimed is:

1. A braking device for vehicles, comprising:
a collision sensing means for sensing a vehicle collision and outputting a signal corresponding thereto; and
an emergency braking means for causing a parking brake to perform a braking operation in response to the signal from the collision sensing means.

2. The braking device as claimed in claim 1, wherein the collision sensing means comprises:
a center G sensor unit for sensing impact acceleration;
a front G sensor unit for sensing deceleration generated upon a low-speed collision;
a safing sensor unit for outputting an impact response signal only when a vehicle is decelerated due to a forward vehicle collision; and
a control unit for outputting a control signal in response to input signals from the center G sensor unit, the front G sensor unit and the safing sensor unit.

3. The braking device as claimed in claim 1, wherein the emergency braking means further comprises:
a gas generator unit for generating high pressure gas in response to the signal from the collision sensing means; and
a spindle for winding a parking cable fastened to a parking brake pedal, said spindle being actuated by high pressure gas generated from the gas generator unit.

4. The braking device as claimed in claim 1, wherein the emergency braking means comprises:
a driving unit which is operated in response to the output signal from the collision sensing means;
a ratchet unit adapted to be connected to a braking cable cooperating with a parking brake, said ratchet being driven by the driving unit; and
a locking unit intermittently controlling rotational operation of the ratchet unit.

5. A vehicle braking device, comprising:
an accelerometer to generate a signal representative of a sudden change in acceleration of a vehicle; and
an actuating unit configured to be operatively connected to a brake cable, said actuating unit communicating with the accelerometer to tension the brake cable in response to said signal.

6. The vehicle braking device of claim 5, further comprising plural accelerometers communicating with a control unit, wherein the control unit interprets said signals and outputs an actuating signal to the actuating unit.

7. The vehicle braking device of claim 5, wherein said actuating unit comprises:
a gas generator actuated in response to said signal;l and
a spindle mechanism driven by gas generated by the gas generator, said spindle being configured and dimensioned to wind the brake cable thereon.

8. The vehicle braking device of claim 7, wherein said gas generator comprises a powder ignition device.

9. The vehicle braking device of claim 5, wherein said actuating unit comprises:
a motor actuated in response to said signal;
a rotating arm driven by said motor, said arm being configured and dimensioned for securing the braking cable to an end thereof.

10. The vehicle braking device of claim 9, further comprising a ratchet mechanism cooperating with said rotating arm to secure said arm in a cable tensioned position.

11. The vehicle braking device of claim 9, wherein said rotating arm is mounted on a shaft driven by a gear meshed with a gear mounted on the motor.
